(19) United States
(12) Patent Application Publication
(10) Pub. No.: US 2009/0068554 A1
(43) Pub. Date: Mar. 12, 2009

(54) SEPARATOR FOR LEAD-ACID RECHARGEABLE BATTERY

(75) Inventor: Sandra Johns, Sarstedt (DE)

Correspondence Address: FOLEY & LARDNER LLP, 777 EAST WISCONSIN AVENUE, MILWAUKEE, WI, 53202-5306, US

(73) Assignee: VB Autobatterie & CO. KGaA

(21) Appl. No.: 12/233,423

(22) Filed: Sep. 18, 2008

Related U.S. Application Data
(63) Continuation of application No. PCT/DE2007/000565, filed on Mar. 28, 2007.

(30) Foreign Application Priority Data
Mar. 28, 2006 (DE) DE102006014691.3

(51) Int. Cl. H01M 2/14

(52) U.S. Cl. 429/129

(57) ABSTRACT

A separator for separation of opposite-polarity electrode plates in a lead-acid rechargeable battery includes two separator leaves connected together at rim areas which rest on one another to form a pocket which is open on one side for insertion of an electrode plate. A basic material thickness of the separator leaves at the rim areas increases from an outer edge of a rim area in the direction of the contact area of the separator leaf for an electrode plate, and the basic material thickness in the rim area adjacent to the contact area is greater than the basic material thickness in the contact area.

### CROSS-REFERENCE TO RELATED PATENT APPLICATIONS

This application is a Continuation of International Patent Application No. PCT/DE2007/000565 filed Mar. 28, 2007, which claims priority to German Priority Patent Application No. DE 10 2006 014 691.3 filed Mar. 28, 2006. The disclosures of International Patent Application No. PCT/DE2007/000565 filed Mar. 28, 2007 and German Priority Patent Application No. DE 10 2006 014 691.3 filed Mar. 28, 2006 are incorporated herein by reference in their entireties.

### BACKGROUND

The present application relates to separators for use in batteries. More specifically, the present application relates to separators for use in lead-acid rechargeable batteries.

As is known, separators are used in rechargeable batteries in order to electrically isolate electrode plates of opposite polarity from one another so that an electrically conductive path is in each case formed between two electrodes via the electrolytes.

In lead-acid rechargeable batteries, the typical separator is a porous membrane having ribs running parallel on one surface. The ribs are normally mounted so that they rest on the positive plate, so that a smooth side faces the negative plate. However, it is also possible for the side facing the negative plate to be provided with ribs as well, or for the assembly process to be reversed. It is known for separators to be in the form of a pocket which is open at the top, in that a separator leaf is manufactured which has a length which is somewhat greater than the height of two separators. The leaf is folded in two and, for example, the side areas are welded to one another, thus forming the pocket which is open at the top.

EP 0 541 124 B1 discloses a separator of the type mentioned initially, which is like a pocket in the known manner with ribs directed inwards, in order to hold a positive electrode plate. The ribs run vertically and parallel to one another in the central area of the separator. In the side rim area, the ribs comprise short rib sections which run parallel to one another and run horizontally or at an angle to vertical ribs in the central area. The second ribs, which are arranged in the rim area, have a lower rib height than the first ribs, which are arranged in the central area, and are used to rest on the edges of the positive electrode plate when inserted in the pocket.

EP 0 994 518 B1 likewise discloses a separator which is in the form of a pocket and whose ribs point towards the outside of the pocket. Vertical ribs are formed in the central area, while the side rim areas have a multiplicity of relatively small ribs. The ribs have a square or rectangular cross section and are used to reduce the contact area of the separator, in particular on the positive electrode plate, since oxygen can be formed there and would result in corrosion of a separator material resting flat on it. In the central area and in the side wall area, the ribs are therefore designed such that gases which are evolved can escape to the side of the rechargeable battery which is open at the top.

The ribs must have a certain amount of robustness, resulting in a certain minimum width. The separators should also be designed such that the electrode plates can be moved laterally relative to the separators, in particular relative to separators in the form of pockets, in order to allow alignment of the electrode plates.

U.S. Pat. No. 5,558,952 discloses a pocket separator whose two layers which are connected to one another on two mutually opposite rims have central ribs which run parallel to the two rims. Obliquely positioned ribs on both layers, whose height decreases from the inside outwards with respect to the respective layer, are located at the rim of the separator. The ribs are located in the obliquely running part of the separator pocket, so that they have an area which is located relatively well inwards and runs diagonally with respect to the edge of a plate electrode which has been inserted into the separator pocket. The decrease in the height of the rib towards the outside is dependent on the two layers being joined together by the rim areas, as a result of which the ribs of the two layers have a cross section in which they run at an angle towards one another.

The basic material thickness of the separator leaf is in contrast constant. Rims which rest on one another are connected adjacent to the inclined ribs which run at an angle.

U.S. Pat. No. 6,001,503 discloses separators in the form of pockets for lead-acid rechargeable batteries, which have a rim area which is provided with a multiplicity of ribs which are located closely adjacent to one another and whose height is low. Two separator leaves which rest on one another are connected to one another in the outer area, with the separator leaves being joined together and making contact with the side edge of an electrode plate in the pocket.

U.S. Pat. No. 6,410,183 B2 discloses a battery separator for lead-acid rechargeable batteries which, in order to increase the penetration resistance, has a multiplicity of additional small ribs in the shoulder areas, adjacent to which two mutually adjacent separator leaves are connected to one another.

A similar embodiment is disclosed in WO 2005/015661 A1. The additional ribs on the rim areas have a sawtooth shape.

Furthermore, DE 102 52 674 B4 discloses a separator in which further ribs with a rising rib profile are provided in the rim area in addition to a number of first ribs, which further ribs, when the adjacent electrode is in the symmetrically adjusted state, rest on the surface of the electrode with a linear edge that is formed at the highest point on the rise of the rib profile.

U.S. Pat. No. 963,284 A discloses a separator for rechargeable batteries having ribs and rim areas of the same thickness as the ribs.

One issue associated with conventional separators in the form of pockets is that the electrode plates are firmly clamped against the edge areas there, once the separator leaves on one another have been joined. The electrode plates can then no longer easily be aligned, resulting in an increase in the risk of sharp edges of the electrode plates cutting through the separators.

It would be advantageous to provide a better separator and a lead-acid rechargeable battery, containing a separator, in which the penetration resistance, the capability to join the rim areas of separator leaves which rest on one another, and the capability to move the electrode plates are improved.

### SUMMARY

An exemplary embodiment relates to a separator for separation of opposite-polarity electrode plates in a lead-acid rechargeable battery that includes two separator leaves connected together at rim areas which rest on one another to form a pocket which is open on one side for insertion of an electrode plate. A basic material thickness of the separator leaves at the rim areas increases from an outer edge of a rim area in the direction of the contact area of the separator leaf for an electrode plate, and the basic material thickness in the rim area adjacent to the contact area is greater than the basic material thickness in the contact area.

Another exemplary embodiment relates to a separator for a lead-acid rechargeable battery that includes two separator leaves coupled together to form a pocket that is configured to receive an electrode plate therein. Each of the separator leaves includes a contact area configured to contact a surface of an electrode plate and at least one rim area provided adjacent the contact area for coupling to a rim area of the other separator leaf. The basic material thickness of each of the rim areas increases from a first location at an outer edge of the rim areas to a second location adjacent the contact area, wherein the basic material thickness of the contact area is less than the basic material thickness of the rim areas at the second location

Another exemplary embodiment relates to a lead-acid rechargeable battery that includes at least one set of electrodes composed of alternately arranged positive and negative electrodes which are in the form of plates. Separators are provided to separate the positive and negative electrodes from each other. The separators each include two separator leaves coupled together to form pockets which are open on one side for insertion of an electrode plate. Each of the separator leaves includes a contact area configured to contact a surface of an electrode plate and rim areas provided adjacent the contact area for coupling the separator leaves together. A basic material thickness of the separator leaves at the rim areas increases from an outer edge of the rim areas in the direction of the contact area, and the basic material thickness in the rim areas adjacent the contact area is greater than the basic material thickness of the contact area.

### BRIEF DESCRIPTION OF THE DRAWINGS

FIG. 1 shows a cross-sectional view of a separator leaf with ribs and rim areas which run in a wedge shape and have an increased basic material thickness.

FIG. 2 shows a cross-sectional detail view of a rim area of the separator leaf shown in FIG. 1.

FIG. 3 shows a cross-sectional detail view of the contact area, adjacent to the rim area, of the separator leaf shown in FIG. 1.

FIG. 4 shows a cross-sectional detail view of a rim area, formed in a wedge shape from webs, of a separator leaf.

### DETAILED DESCRIPTION

According to an exemplary embodiment, a lead-acid rechargeable battery has at least one set of electrodes composed of alternately arranged positive and negative electrodes which are in the form of plates and between which the separators for separation of the opposite-polarity electrodes are arranged, with the separators each being formed from two separator leaves by joining rim areas, which rest on one another, of separator leaves to form pockets which are open on one side for insertion of an electrode plate.

The separator is provided for separation of opposite-polarity electrode plates in such a lead-acid rechargeable battery and has two separator leaves which are connected to one another on rim areas which rest on one another to form a pocket which is open on one side for insertion of an electrode plate.

According to an exemplary embodiment, the basic material thickness of the separator leaves at the rim areas increases from the outer edge of a rim area in the direction of the contact area of the separator leaf for an electrode plate, and the basic material thickness in the rim area adjacent to the contact area is greater than the basic material thickness in the contact area.

In contrast to the conventional solutions, in which the geometry may have been changed adjacent to the rim areas by additional ribs, it is now proposed that the basic material thickness of the separator leaf itself be increased at the rim areas. A step is therefore formed between the contact area for an electrode plate and the adjacent rim area. This step prevents the electrode plate from becoming jammed in the separator leaves, and makes it possible to align the electrode plate better. The extra material in the rim area leads to a significant increase in the penetration resistance of the separators. Since the basic material thickness decreases again from the contact area outwards in the rim area, that is to say it has a wedge-shaped cross section, this also results in material stress being kept away from the edges of electrode plates in the pockets.

It is advantageous to arrange at least one rib which projects beyond the basic material thickness in the rim area adjacent to the contact area. This at least one rib in the rim area makes it possible to assist the alignment and adjustment of electrode plates in the pockets. Apart from this, the surface of the rim areas is smooth, in order to ensure that separator leaves which lie on one another are joined in a simple and robust manner.

It is also advantageous to provide a plurality of ribs, which project beyond the basic material thickness of the contact area, in the normal manner in the contact area for an electrode plate.

In this case, the separators may have selected main ribs for positioning an electrode plate with a rib height which is greater than the rib height of secondary ribs.

The separator pockets can be designed such that the ribs point outwards, and negative electrode plates are held in the internally smooth separator pocket. However, it is particularly advantageous for ribs to be provided in the interior of the separator pocket, and for the pockets to hold positive electrode plates.

The rim areas, which have a wedge-shaped cross section and rest flat on one another, of associated separator leaves may be adhesively bonded, welded or knurled to one another to form a pocket. Any other suitable joining methods are equally feasible.

According to an exemplary embodiment, the basic material thickness of the separator leaves at the rim areas increases from the outer edge of a rim area in the direction of the contact area of the separator leaf for an electrode plate, and the basic material thickness in the rim area adjacent to the contact area is greater than the basic material thickness in the contact area.

FIG. 1 shows a cross-sectional view of a separator leaf 1 which has a contact area A for an electrode plate (not illustrated) and rim areas R on the side edges. Main and secondary ribs 2a, 2b are provided in the normal manner in the contact area A.

The rim areas R have a width B_{R}, and have a central basic material thickness D_{R} which is greater than the basic material thickness of the separator leaf 1 (ignoring the ribs) in the contact area A.

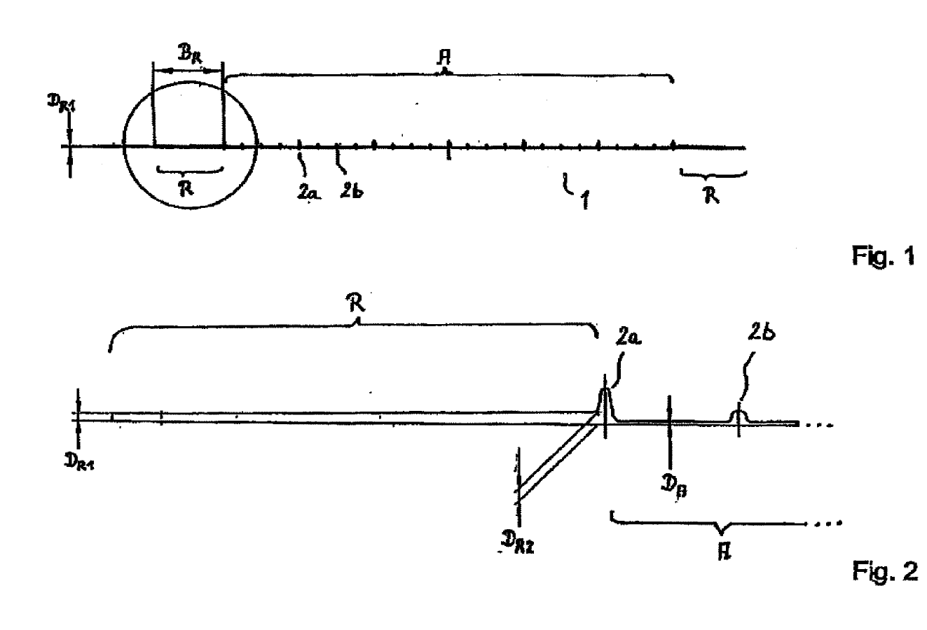

FIG. 2 shows an enlarged detail view of the left-hand rim area R sketched in FIG. 1. As can be seen, the basic material thickness D_{R} (ignoring the main rib 2a) in the boundary area between the rim area R and the contact area A is greater than the basic material thickness D_{A} of the contact area. As can also be seen, the rim area R tapers outwards in a wedge shape, by the basic material thickness D_{R1} of the separator leaf 1 adjacent to the rim area R increasing from the outer edge of the rim area R in the (direct) direction of the contact area A of the separator leaf 1 to the basic material thickness D_{R2}, which is greater than the basic material thickness D_{R1} adjacent to the outer edge.

The wedge-shaped tapering of the rim areas results in a reduction in the material stress on the edges of electrode plates in the pockets.

As can also clearly be seen, the rim areas R have no ribs at all and have a smooth surface, so that the rim areas R of separator leaves 1 which are adjacent to one another and have been joined together to form a pocket rest flat on one another. This also improves the capability to join the associated separator leaves, for example by adhesive bonding, welding, for example ultrasound welding, knurling etc.

The penetration resistance of the separator pockets is improved by the increased basic material thickness D_{R2} in the rim area R adjacent to the contact area A in comparison to the basic material thickness D_{A} of the contact area A, and the extra material associated with this.

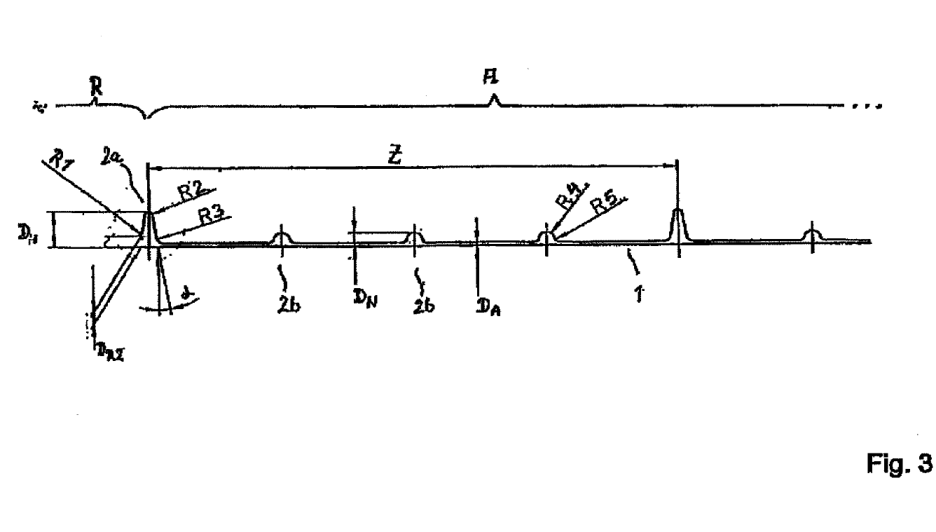

FIG. 3 shows a detail of the separator leaf 1 in the area of the contact section A, in the form of a cross section. This clearly shows that the main ribs 2a have a first radius R1 in the transition area to the rim area R, which first radius R1 preferably corresponds to the radius R3 in the transitional area to the contact area A, but may also differ from it. By way of example, the radii R1 and R3 may be 0.3 mm.

The radius R2 of the curvature of the main ribs 2a is considerably less than the transitional-area radii R1 and R3, and, for example, is 0.15 mm.

As can also be seen, a total number of, for example, three secondary ribs 2b are arranged between the main ribs 2a, 2b, and extend in the longitudinal direction of the separator leaf 1. As can clearly be seen, the head radius R4 of the secondary ribs 2b is considerably greater than the head radius R2 of the main ribs 2a, and is, for example, 0.3 mm, that is to say twice as great as the head radius R2 of the main ribs 2a. As can also be seen, the transitional-area radii R5 of the secondary ribs 2b to the separator leaf 1 are less than the transitional-area radii R1 and R3 of the main ribs 2a. For example, the transitional-area radius R5 is 0.2 mm.

The height D_{N} of the secondary ribs 2b is less than the height D_{H} of the main ribs. The ratio between the height D_{H} of the main ribs and D_{N} of the height of the secondary ribs 2a is preferably about 2.5. In one preferred embodiment, the height D_{H} is 1.5 mm, and the height D_{N} of the secondary ribs 2b is 0.6 mm. The basic material thickness D_{A} of the separator leaf 1 is even considerably less than this and, preferably, is in the range from 0.2 to 0.1 mm, 0.15 mm. The ratio between the height D_{N} of the secondary rib 2b and the basic material thickness D_{A} of the separator leaf 1 is preferably in the range between 3 and 5, and is preferably about 4.

As can also be seen, a relatively small total number of three secondary ribs 2b are provided over the surface in the lateral direction in the intermediate space Z between two successive main ribs 2a. In comparison to conventional ribs, the extra material, formed by the secondary ribs 2b with the aid of the relatively great height D_{N} of the secondary ribs 2b and in comparison to the conventional secondary ribs has a relatively great width and relatively great head radius R4 is so great that this results in the separator leaf 1 being relatively highly stiff in the longitudinal direction. This has the advantage that the process cycle rate to produce the separator pockets and to place the electrode plates in the separator pockets which are formed by folding up and joining the separator leaves 1 adjacent to the rim areas R can be increased.

As can also be seen from FIG. 3, the main ribs 2a are inclined at an angle α of, for example, about 9°. This inclination angle means that the electrode plates which rest on the main ribs 2a can be moved sufficiently easily, while on the other hand avoiding the separator leaves 1 from becoming corrugated. The relatively broad secondary ribs 2b likewise counteract corrugation.

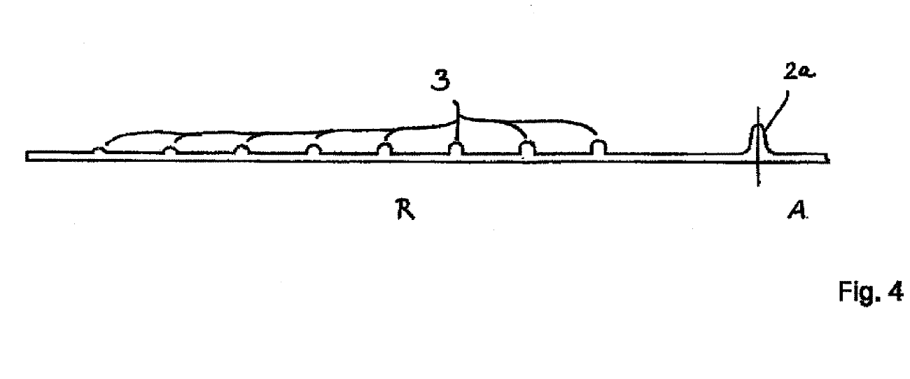

FIG. 4 shows a cross-sectional detail view of a rim area, which is wedge-shaped because of the webs 3, of a separator leaf 1. The webs 3 are arranged at a distance from one another and, starting from the last main rib 2a in the contact area A have heights which decrease in the direction of the side edge of the separator plate 1, so that the average basic material thickness of the separator leaf 1 adjacent to the rim area R increases from the outer edge of the rim area R in the (direct) direction of the contact area A. The webs 3 advantageously allow material to be saved in comparison to a solid, wedge-shaped rim area R as sketched in FIG. 2.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the separator and rechargeable battery as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A separator for separation of opposite-polarity electrode plates in a lead-acid rechargeable battery, the separator comprising two separator leaves connected together at rim areas which rest on one another to form a pocket which is open on one side for insertion of an electrode plate, wherein a basic material thickness of the separator leaves at the rim areas increases from an outer edge of a rim area in the direction of the contact area of the separator leaf for an electrode plate, and the basic material thickness in the rim area adjacent to the contact area is greater than the basic material thickness in the contact area.

2. The separator of claim 1, further comprising at least one rib provided in the rim area adjacent to the contact area, the at least one rib projecting beyond the basic material thickness.

3. The separator of claim 2, wherein the at least one rib comprises a plurality of ribs provided in the rim area adjacent to the contact area, wherein the plurality of ribs comprise main ribs and secondary ribs, wherein the main ribs have a rib height that is greater than a rib height of the secondary ribs.

4. The separator of claim 3, wherein the plurality of ribs are provided in the interior of the pocket.

5. The separator of claim 1, further comprising a plurality of ribs provided in the contact area that project beyond the basic material thickness of the contact area.

6. The separator of claim 5, wherein the ribs are provided in the interior of the pocket.

7. The separator of claim 1, wherein the rim areas of the separator leaves have a wedge-shaped cross section.

8. The separator of claim 7, wherein the rim areas of the separator leaves are adhesively bonded to each other to form the pocket.

9. The separator of claim 7, wherein the rim areas of the separator leaves are welded to each other to form the pocket.

10. The separator of claim 7, wherein the rim areas of the separator leaves are knurled together to form the pocket.

11. A separator for a lead-acid rechargeable battery comprising:
two separator leaves coupled together to form a pocket that is configured to receive an electrode plate therein, each of the separator leaves comprising a contact area configured to contact a surface of an electrode plate and at least one rim area provided adjacent the contact area for coupling to a rim area of the other separator leaf;
wherein the basic material thickness of each of the rim areas increases from a first location at an outer edge of the rim areas to a second location adjacent the contact area, wherein the basic material thickness of the contact area is less than the basic material thickness of the rim areas at the second location.

12. The separator of claim 11, wherein the pocket is open on one side.

13. The separator of claim 11, further comprising at least one rib provided in each of the rim areas that projects beyond the basic material thickness of the rim areas.

14. The separator of claim 13, wherein the at least one rib comprises a plurality of ribs.

15. The separator of claim 14, wherein the plurality of ribs comprise main ribs and secondary ribs, wherein the main ribs have a rib height that is greater than a rib height of the secondary ribs.

16. The separator of claim 14, wherein the plurality of ribs are provided in the interior of the pocket.

17. The separator of claim 11, further comprising a plurality of ribs provided in the contact area that project beyond the basic material thickness of the contact area.

18. The separator of claim 17, wherein the ribs are provided in the interior of the pocket.

19. The separator of claim 11, wherein the rim areas of the separator leaves have a wedge-shaped cross section.

20. A lead-acid rechargeable battery comprising:
at least one set of electrodes composed of alternately arranged positive and negative electrodes which are in the form of plates; and
separators provided to separate the positive and negative electrodes from each other, the separators each comprising two separator leaves coupled together to form pockets which are open on one side for insertion of an electrode plate, each of the separator leaves comprising a contact area configured to contact a surface of an electrode plate and rim areas provided adjacent the contact area for coupling the separator leaves together;
wherein a basic material thickness of the separator leaves at the rim areas increases from an outer edge of the rim areas in the direction of the contact area, and the basic material thickness in the rim areas adjacent the contact area is greater than the basic material thickness of the contact area.

21. The lead-acid rechargeable battery of claim 20, wherein at least one rib is provided in each of the rim areas that projects beyond the basic material thickness of the rim areas.

22. The lead-acid rechargeable battery of claim 20, wherein a plurality of ribs are provided in the contact area that project beyond the basic material thickness of the contact area.

23. The lead-acid rechargeable battery of claim 22, wherein the ribs are provided in the interior of the pocket.

24. The lead-acid rechargeable battery of claim 20, wherein the separators include main ribs and secondary ribs, the main ribs configured for positioning an electrode plate and having a rib height that is greater than the rib height of secondary ribs.

25. The lead-acid rechargeable battery of claim 24, wherein the ribs are provided in the interior of the pocket.

26. The lead-acid rechargeable battery of claim 20, wherein the rim areas have a wedge-shaped cross section.

27. The lead-acid rechargeable battery of claim 20, wherein the rim areas of the separator leaves are coupled together.

28. The lead-acid rechargeable battery of claim 27, wherein the rim areas of the separator leaves are coupled together by adhesive bonding, welding, or knurling to form the pocket.
